(19) United States
(12) Patent Application Publication
(10) Pub. No.: US 2013/0308053 A1
(43) Pub. Date: Nov. 21, 2013

(54) Video Signal Processing Apparatus and Video Signal Processing Method

(71) Applicant: Kabushiki Kaisha Toshiba, Tokyo (JP)

(72) Inventor: Hiroaki Komaki, Tachikawa-shi (JP)

(21) Appl. No.: 13/953,638

(22) Filed: Jul. 29, 2013

Related U.S. Application Data
(63) Continuation of application No. 12/966,571, filed on Dec. 13, 2010.

(30) Foreign Application Priority Data
Jan. 28, 2010 (JP) 2010-016230

(51) Int. Cl. H04N 7/01

(52) U.S. Cl. CPC H04N 7/0117
USPC 348/554

(57) ABSTRACT

According to one embodiment, an apparatus comprises a memory and one or more hardware processors that are coupled to the memory. The one or more processors are configured to: (A) determine whether an input video signal is one of (i) a video signal of a film material or (ii) a video signal of a video material, (B) perform super-resolution processing on both of a color component and an luminance component of the input video signal if the input video signal is the video signal of the film material, and (C) perform super-resolution processing on the color component of the input video signal without performing super-resolution processing on the luminance component if the input video signal is the video signal of a video material.

### CROSS-REFERENCE TO THE RELATED APPLICATION(S)

The application is a continuation of U.S. patent application Ser. No. 12/966,571, which is based upon and claims priority from prior Japanese Patent Application No. 2010-016230, filed on Jan. 28, 2010, the entire contents of both of which are incorporated herein by reference.

### FIELD

Embodiments described herein generally relate to a video signal processing apparatus and a video signal processing method for performing content-adaptive super-resolution processing using a general-purpose processor.

### BACKGROUND

In recent years, the processing abilities of CPUs (central processing units) have been increased greatly by employment of the multicore architecture and other factors. It is expected that the processing abilities of image processing etc. can be increased further by causing a CPU having such a high processing ability to cooperate with other hardware.

Conventionally, in the field of image processing, spectrum expansion is performed to increase the vertical resolution in up-sampling interlaced video. An example of such technique is disclosed in JP-A-2007-300687.

For example, JP-A-2008-283342 discloses a noise eliminating device and method for reducing the image quality degradation of a video signal of a film material (telecine-converted video signal). In this technique, the noise elimination level is varied according to an input signal.

For example, JP-A-2000-013752 discloses a technique, which relates to I/P conversion in image processing, for selecting an I/P conversion method dynamically from plural I/P conversion methods according to the CPU load.

However, no techniques for changing the image quality enhancement processing method adaptively to the kind of a video source have been disclosed.

### BRIEF DESCRIPTION OF THE DRAWINGS

A general configuration that implements the various features of the present invention will be described with reference to the drawings. The drawings and the associated descriptions are provided to illustrate embodiments of the invention and not to limit the scope of the invention.

FIG. 1 is a schematic block diagram showing a configuration of a DTV set according to an embodiment of the present invention.

FIG. 2 is a block diagram showing a configuration of a function expanding block according to the embodiment.

FIG. 3 illustrates an operation relating to super-resolution processing on video of a video material according to the embodiment.

FIG. 4 illustrates an operation relating to super-resolution processing on video of a film material according to the embodiment.

FIG. 5 is a block diagram showing an example broadcast receiving apparatus using a video signal processor according to the embodiment.

### DETAILED DESCRIPTION

According to the embodiments described herein, there is provided a video signal processing apparatus including: a determining module configured to determine whether an input video signal is a video signal of a film material or a video signal of a video material; and a resolution enhancing module configured to perform super-resolution processing on both of color information and luminance information of the input video signal when the determining module determines that the input video signal is a video signal of a film material, and performing super-resolution processing on color information of the input video signal when the determining module determines that the input video signal is a video signal of a video material.

Embodiments according to the present invention will be described in detail with reference to the accompanying drawings. The scope of the claimed invention should not be limited to the examples illustrated in the drawings and those described in below.

The embodiment relates to conversion processing from 4:2:0 (60i) video into YUV 4:2:2 (60i) video or YUV 4:4:4 (24p) video and super-resolution processing (image quality enhancement processing which adds high-frequency components using a model) while utilizing a general-purpose processor.

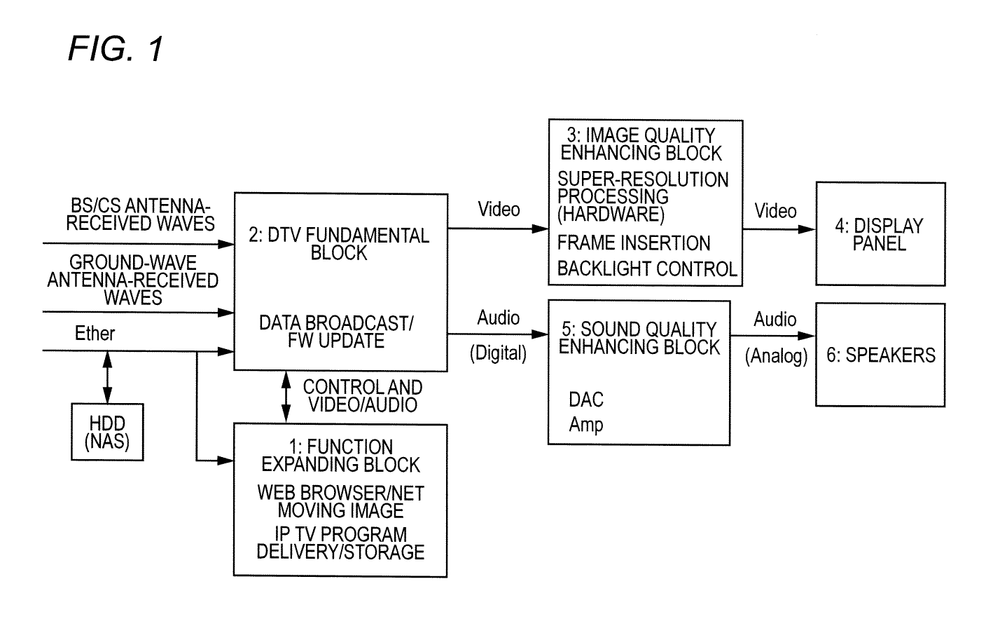

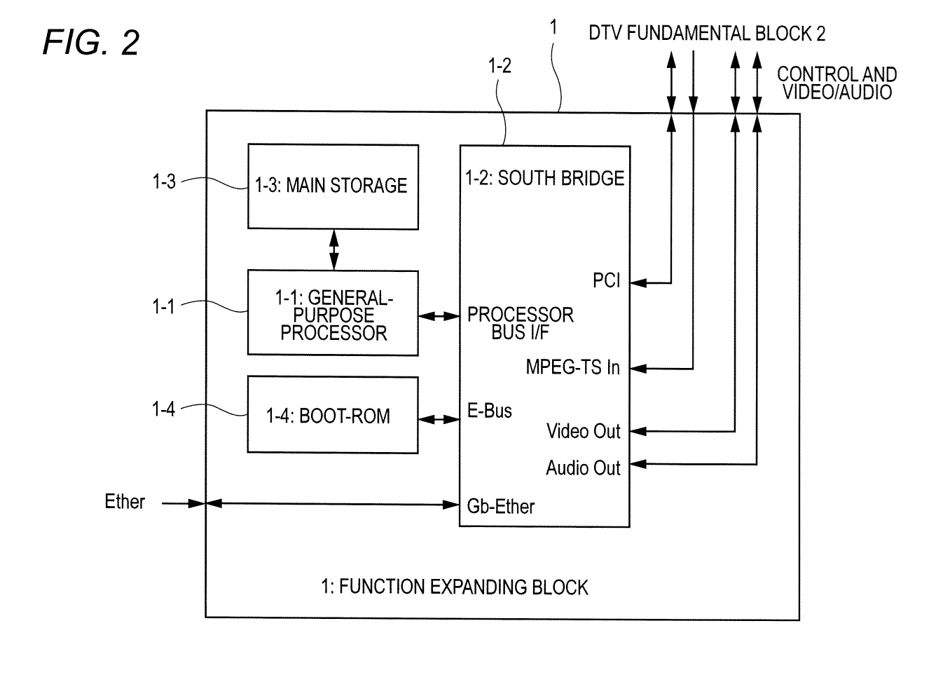

FIGS. 1 and 2 show a functional configuration of a DTV set according to the embodiment. FIG. 1 is a block diagram showing the configuration of the DTV set (a video signal processor etc.) according to the embodiment of the invention.

The video signal processor is composed of a function expanding block 1, a DTV fundamental block 2, an image quality enhancing block 3, and a display panel 4. The video signal processor is accompanied by a sound quality enhancing block 5 and speakers 6 as related blocks.

The blocks other than the function expanding block 1 will be described first. The DTV fundamental block 2 is connected to a BS/CS antenna (not shown) and receives BS/CS digital antenna-received waves. The DTV fundamental block 2 is also connected to a ground-wave antenna (not shown) and receives ground-wave digital antenna-received waves. Furthermore, connected to a network, the DTV fundamental block 2 is configured so as to perform not only general-purpose Web access but also access to an external NAS (recording and reproduction), DLNA functions (DMS: digital media server; DMP: digital media player; and DMR: digital media renderer), a VOD (digital on demand) function, gadget information collection, etc.

The image quality enhancing block 3 receives YUV video signals from the DTV fundamental block 2, performs super-resolution processing, frame insertion processing, backlight control, etc., and outputs resulting RGB video signals to the display panel 4.

The sound quality enhancing block 5 receives a digital audio signal from the DTV fundamental block 2, performs DAC processing, amplification processing, etc., and outputs a resulting analog audio signal to the speakers 6.

FIG. 2 is a block diagram showing the configuration of the function expanding block 1, which is composed of a general-purpose processor 1-1, a south bridge 1-2, a main storage 1-3, and a boot-ROM 1-4.

The general-purpose processor 1-1 is a general-purpose processor (a multicore processor module and a north bridge) which is the core of the function expanding block 1.

The south bridge 1-2 is a companion chip which operates as an input/output function (what is called a south bridge function) for the general-purpose processor 1-1. The south bridge 1-2 incorporates the following function blocks (not shown):

(1) Processor bus interface (e.g., Flex IO)

(2) E-Bus (the boot-ROM 1-4 for booting the general-purpose processor 1-1 is connected)

(3) Gb-Ether (communication channel to the network and the NAS)

(4) PCI (communication channel to the DTV fundamental block 2)

(5) MPEG-TS In (a broadcast-wave reception stream from the DTV fundamental block 2 is input)

(6) Video Out (video output to the DTV fundamental block 2)

(7) Audio Out (audio output to the DTV fundamental block 2)

The main storage 1-3 is a memory which operates as a main storage function for the general-purpose processor 1-1.

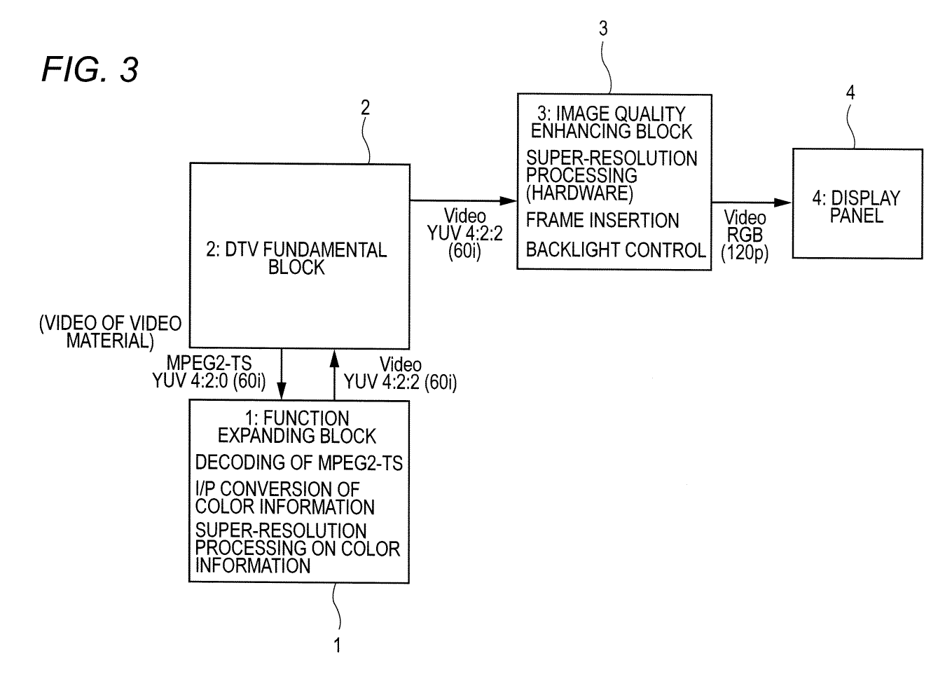

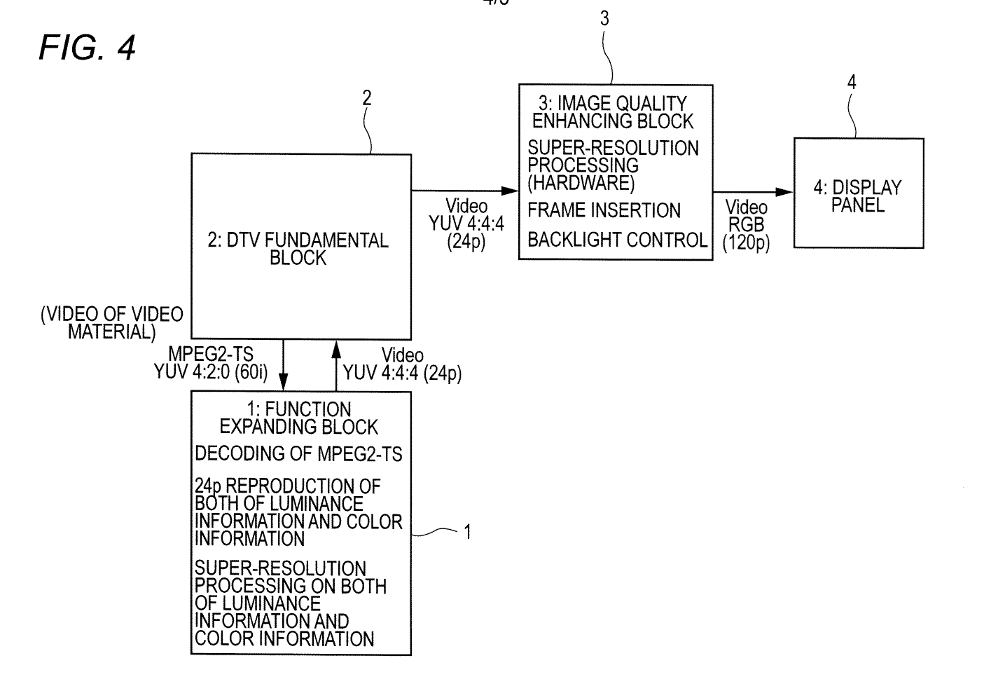

Next, operations that relate to respective pieces of super-resolution processing for video of a video material and video of a film material and that are mainly performed by the function expanding block 1 of FIG. 2 will be described with reference to FIGS. 3 and 4. For techniques for discriminating between video of a video material and video of a film material, refer to Japanese Patent Application No. 2009-156004 (counterpart U.S. patent application Ser. No. is: Ser. No. 12/700,503), for example.

FIG. 3 illustrates an operation relating to super-resolution processing on video of a video material according to the embodiment.

The following processing is performed on video of a video material of broadcast waves (MPEG2-TS, YUV 4:2:0 (60i)) received from the DTV fundamental block 2. Only color information, which is reduced to ¼ of luminance information in information amount when decoding into baseband information is performed, is I/P-converted and resulting 60p color information is subjected to super-resolution processing which is based on a self-congruity model, and (a half of) a result is added to the original 60i luminance information. Resulting baseband video of YUV 4:2:2 (60i) is returned to the DTV fundamental block 2.

The signal scheme YUV 4:2:0 is such that among 2 (horizontal)×2 (vertical) pixels of an image one pixel is taken from the top two pixels for a Cb signal and one pixel is taken from the bottom two pixels for a Cr signal. The pixel positions of Cb and Cr are reversed every frame. For a luminance signal, information is taken from each pixel (this scheme is employed in digital broadcast). The information amount per pixel is 12 bits (=8 bits (Y)+16/4 bits (UV)). This scheme is employed widely as a video format of broadcast and DVD video.

The signal scheme YUV 4:2:2 is such that one pixel is taken from two horizontal pixels for a color signal. For a luminance signal, information is taken from each pixel. Where each component is quantized into 8 bits, each pixel is given an information amount of 16 bits (8 bits (Y)+16/2 bits (UV)). This scheme is mainly employed as a format of video for business purposes.

The signal scheme YUV 4:4:4, which will be described later, is such that four pixels are sampled from four horizontal pixels for each of a luminance component and two color difference components. Where each component is quantized into 8 bits, each pixel is given an information amount of 24 bits (8 bits (Y)+16/1 bits (UV)).

FIG. 4 illustrates an operation relating to super-resolution processing on video of a film material according to the embodiment.

For video of a film material of broadcast waves (MPEG2-TS, YUV 4:2:0 (60i)) received from the DTV fundamental block 2, 24p reproduction is performed (for both of color information and luminance information) when decoding into baseband information is performed. Both of resulting 24p color information and luminance are subjected to super-resolution processing using self-congruity. Resulting baseband video of YUV 4:4:4 (24p) is returned to the DTV fundamental block 2.

A modification is possible in which the concept of the embodiment is applied to super-resolution processing involving plural frames. Super-resolution processing which is based on a conventional imaging model, involves plural frames, and is heavier in load than super-resolution processing using self-incongruity is performed by using spare processor power obtained in the above embodiment through simplified I/P conversion.

The conversion processing from 4:2:0 (60i) video into YUV 4:2:2 (60i) video or YUV 4:4:4 (24p) video and the super-resolution processing using a general-purpose processor have been described above with reference to FIGS. 3 and 4.

Motion-adaptive I/P conversion that is equivalent to motion-adaptive I/P conversion employed in existing DTV sets is too heavy in load to be software-implemented on a general-purpose processor. In the processing of FIG. 3, in the case where a general-purpose processor of hundreds of gigaflops is used, only color information which is reduced to ¼ of luminance information in information amount is subjected to software-implemented I/P conversion and super-resolution processing on the general-purpose processor. As a result, advantages of the super-resolution processing using self-congruity that is performed on color information can be added to advantages of reconfiguration-type super-resolution processing that is performed on a luminance signal as performed in existing DTV sets.

In contrast, where the subject video is 24p video of a film material, the load of I/P conversion is very light (simple combining of a top field and a bottom field). Therefore, in the processing of FIG. 4, super-resolution processing using self-congruity which is advantageous over reconfiguration-type super-resolution processing which is hardware-implemented in existing DTV sets is performed using spare processor power. Super-resolution processing that is superior to the super-resolution processing of existing DTV sets can thus be realized.

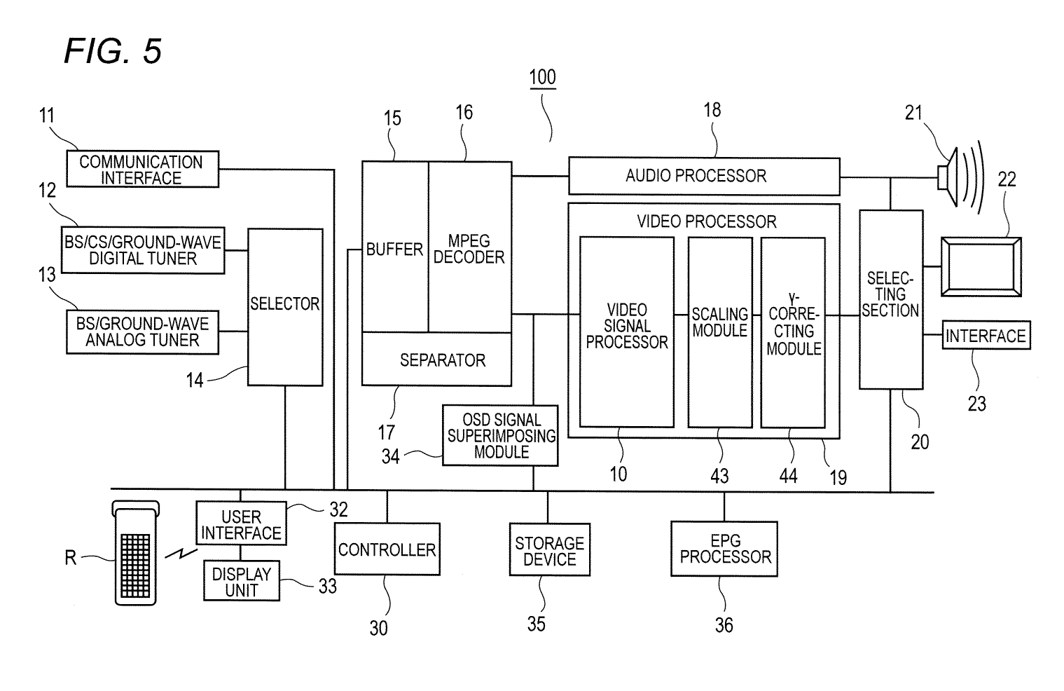

Next, a specific example in which the video signal processor according to the embodiment of the invention is implemented actually by hardware. FIG. 5 is a block diagram showing an example configuration of a digital broadcast receiving apparatus as a specific example of a broadcast receiving apparatus that employs the video signal processor according to the embodiment.

In an example broadcast receiving apparatus 100 shown in FIG. 5, a controller 30 which controls the entire operation is connected to individual sections via a data bus. The broadcast receiving apparatus 100 includes the controller 30 and an MPEG decoder 16 which is a main reproduction-side section. The broadcast receiving apparatus 100 is equipped with an input selector 14 and an output selector 20. A BS/CS/ground-wave digital tuner 12 and a BS/ground-wave analog tuner 13 are connected to the input selector 14. A communication interface 11 having a LAN function or the like and a mail function is connected to the data bus.

The broadcast receiving apparatus 100 is also equipped with a buffer 15 for temporarily storing a demodulation signal supplied from the BS/CS/ground-wave digital tuner 12, a separator 17 for separating individual kinds of packets of the stored demodulation signal, an MPEG decoder 16 for performing MPEG decoding on video packets and audio packets supplied from the separator 17 and outputting a resulting video signal and audio signal, and an OSD (on-screen display) signal superimposing module 34 for generating a video signal for superimposition of operation information, for example, and superimposing it on the video signal that is output from the MPEG decoder 16. The broadcast receiving apparatus 100 is also equipped with an audio processor 18 for performing amplification processing etc. on the audio signal that is output from the MPEG decoder 16, a video processor 19 for receiving the video signal from the MPEG decoder 16 or the OSD signal superimposing module 34 and performing prescribed video processing on it, the selector 20 for selecting output destinations of a resulting audio signal and video signal, speakers 21 for outputting a sound according to the audio signal supplied from the audio processor 18, a display unit 22 for displaying video on a liquid crystal display panel, for example, according to the video signal supplied from the selector 20, and an interface 23 for performing a communication with an external apparatus.

The video processor 19 is equipped with a video signal processor 10 for luminance-converting an interlaced luminance signal, a scaling module 43 for performing scaling processing, and a [symbol] -correcting module 44 for performing [symbol] correction on a video signal.

Furthermore, the broadcast receiving apparatus 100 is equipped with a storage device 35 for recording, when necessary, video information etc. supplied from the BS/CS/ground-wave digital tuner 12 or the BS/ground-wave analog tuner 13 and an EPG processor 36 for acquiring electronic program guide from a broadcast signal or the like and, for example, displaying it on the screen. The storage device 35 and the EPG processor 36 are connected to the controller 30 via the data bus. The broadcast receiving apparatus 100 is also equipped with a user interface 32 which is connected to the controller 30 via the data bus and receives a user operation directly or via a remote controller R and a display unit 33 for displaying the command signal. The remote controller R enables approximately the same operations as made through the user interface 32 which is provided in the main body of the broadcast receiving apparatus 100, that is, enables such operations as a tuner operation and various kinds of setting.

In the above-configured broadcast receiving apparatus 100, broadcast signals are input to, for example, the BS/CS/ground-wave digital tuner 12, which tunes in to one of those broadcast signals. A demodulation signal in packet form of the selected broadcast signal is separated into individual kinds of packets by the separator 17. Resulting audio packets and video packets are decoded by the MPEG decoder 16 etc. into an audio signal and a video signal, which are supplied to the audio processor 18 and the video processor 19, respectively. In the video processor 19, the video signal processor 10 converts the luminance signal of the received video signal and outputs a video signal having well-balanced characteristics. The video signal is subjected to scaling processing in the scaling module 43 and then [symbol] -corrected by the [symbol] -correcting module 44. A resulting video signal is supplied to the selector 20.

The selector 20 supplies the video signal to the display unit 22, for example, according to a control signal from the controller 30. Video is thus displayed on the display unit 22 according to the video signal. A sound is output from the speakers 21 according to the audio signal.

One of various kinds of operation information, subtitle information, or the like generated by the OSD signal superimposing module 34 is superimposed on a video signal corresponding to a broadcast signal, a resulting video signal is processed by the video processor 19, and video is displayed on the display unit 22 according to a resulting video signal.

In the above-described broadcast receiving apparatus 100, the DTV fundamental block 2 has, as two sets of sections that are deeply related to the invention, a first set consisting of the tuner sections 12 and 13 and the communication interface 11 and a second set for processing a signal supplied from the sections corresponding to the function expanding block 1 that are mainly the MPEG decoder 16 and the video processor 19.

In the video processor 19, the video processor 10 mainly corresponds to the function expanding block 1.

The above video processing system using the general-purpose processor 1-1 is characterized in that content-adaptive super-resolution processing is applied to MPEG-compressed video (e.g., digital broadcast waves) of YUV 4:2:0 (60i) in the following manner. For video of a video material, I/P conversion and super-resolution processing are performed on color information. For video of a film material, 24p reproduction and super-resolution processing are performed on both of luminance information and color information.

To optimize the load of I/P conversion and super-resolution processing in the case of using a general-purpose processor, the embodiment is characterized in that for video of a video material (I/P conversion is complex and hence the load is heavy) I/P conversion and super-resolution processing are performed only on color information, and that for video of a film material 24p reproduction (the load is light because of simple conversion) is performed and super-resolution processing is performed on both of luminance information and color information.

The embodiment provides an advantage that the sense of resolution is enhanced for video of a video material because color super-resolution processing (chroma up-sampling) is added as preprocessing of hardware super-resolution processing (existing technique). Furthermore, for video of a film material, optimum super-resolution processing using a general-purpose processor can be performed on both of luminance information and color information, which would enhance the sense of resolution further.

The invention is not limited to the above embodiment, and can be practiced so as to be modified in various manners without departing from the spirit and scope of the invention. For example, although the embodiment is directed to the video processing using a general-purpose processor, replacing the corresponding processing sections with hardware does not alter the essence of the invention.

Although the embodiments according to the present invention have been described above, the present invention is not limited to the above-mentioned embodiments but can be variously modified. Constituent components disclosed in the aforementioned embodiments may be combined suitably to form various modifications. For example, some of all constituent components disclosed in the embodiments may be removed or may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video signal processing apparatus comprising:
an input module configured to receive an interlaced video signal of a film material or an interlaced video signal of a video signal;
a first converting module configured to perform interlaced/progressive (I/P) conversion on both a color component and a luminance component of the interlaced video signal of the film material that is received by the input module;
a first processing module configured to perform a super-resolution processing on both the color component and the luminance component of the interlaced video signal after the I/P conversion by the first converting module;
a second converting module configured to perform a motion-adaptive I/P conversion on a color component of the interlaced video signal of the video material that is received by the input module; and
a second processing module configured to perform the super-resolution processing on the color component of the interlaced video signal that has been applied after the motion-adaptive I/P conversion by the second converting module,
wherein the super-resolution processing being an image enhancement processing performed by adding high-frequency component using self-congruity.

2. The apparatus of claim 1, wherein the second processing module is configured to perform the super-resolution processing solely on the color component of the interlaced video signal that has been applied after the motion-adaptive I/P conversion by the second converting module.

3. The apparatus of claim 1 further comprising:
a tuner configured to receive a broadcast signal and output the interlaced video signal to the input module.

4. The apparatus of claim 1, wherein the input module is an input selector controlled by a controller.

5. The apparatus of claim 1, wherein first processing module and the second processing module include one or more processors.

6. The apparatus of claim 1, wherein first converting module, the second converting module, the first processing module and the second processing module are software-implemented modules executed by a processor.

7. An apparatus comprising:
a memory; and
one or more hardware processors coupled to the memory, the one or more processors being configured to:
determine whether an input video signal is one of (i) a video signal of a film material or (ii) a video signal of a video material,
perform super-resolution processing on both of a color component and an luminance component of the input video signal if the input video signal is the video signal of the film material, and
perform super-resolution processing on the color component of the input video signal without performing super-resolution processing on the luminance component if the input video signal is the video signal of a video material.

8. The apparatus of claim 7, wherein prior to the one or more processors performing super-resolution processing on both of a color component and an luminance component of the input video signal, the one or more processors are configured to perform interlaced/progressive (I/P) conversion on the video signal of the film material.

9. The apparatus of claim 8, wherein prior to the one or more processors performing super-resolution processing on the color component of the input video signal, performing a motion-adaptive I/P conversion solely on the color component of the video signal of the video material.

10. The apparatus of claim 7, wherein prior to the one or more processors performing super-resolution processing on the color component of the input video signal, performing a motion-adaptive interlaced/progressive (I/P) conversion on the color component of the video signal of the video material.

11. The apparatus of claim 7 further comprising:
a tuner configured to receive a broadcast signal and output the input video signal.

12. A method for processing different types of video signals, comprising:
determining whether an input video signal is a video signal of a film material or a video signal of a video material; and
performing interlaced/progressive (I/P) conversion and subsequent super-resolution processing on both of color information and luminance information of the input video signal in response to the determined input video signal being the video signal of the film material; and
performing a motion-adaptive interlaced/progressive (I/P) conversion and subsequent super-resolution processing on the color information of the input video signal when determined that the input video signal is the video signal of the video material.
